(19) United States
(12) Patent Application Publication
(10) Pub. No.: US 2007/0185811 A1
(43) Pub. Date: Aug. 9, 2007

(54) Authorization of a transaction

(76) Inventors: Dieter Weiss, Munchen (DE); Wolfgang Rankl, Munchen (DE)

Correspondence Address: MARTINE PENILLA & GENCARELLA, LLP, 710 LAKEWAY DRIVE, SUITE 200, SUNNYVALE, CA, 94085, US

(21) Appl. No.: 10/579,961

(22) PCT Filed: Nov. 16, 2004
(86) PCT No.: PCT/EP04/12995

§ 371 Date: Mar. 27, 2007

(30) Foreign Application Priority Data
Nov. 18, 2003 (DE) 103 53 853.4

(51) Int. Cl. G06Q 99/00

(52) U.S. Cl. 705/50

(57) ABSTRACT

In a method for authorizing a transaction by a user with the aid of a terminal which can communicate with a background system, a secret, which is known to the user and to the background system but not to an unauthorized attacker, is used. The background system transmits secret data, which indicate the secret, only to the terminal if the terminal has successfully authenticated itself at the background system. Because, as a rule, secret data of several users are stored in the background system, the terminal detects in advance identification information which identifies the user, and transmits corresponding user identification data to the background system. When the terminal displays the secret to the user, the user can be certain that the terminal is trustworthy. A device and a computer program product comprise corresponding features. The invention provides a technique for authorizing a transaction by a user with the aid of a terminal which enables the user to recognize a falsified terminal.

### BACKGROUND OF THE INVENTION

1. Field of the Invention

The present invention relates in general to the field of electronic execution of transactions and more specifically to the field of authorizing a transaction by a user. In the wording of the present document, a “transaction” should be understood in particular to refer to a legal or factual procedure, the authorization of which by an authorized user must be verifiable without any doubt. Such a transaction may be, for example, an electronic payment or some other financial transaction or an electronic declaration of intent.

2. Description of Related Art

For an electronic authorization of a transaction, it is customary to use a personal feature of the authorizing user that is known only by the user and/or can be given only with the cooperation of the user. In the past, mainly secret numbers (PINs=personal identification numbers) have been used as these personal features, but the use of biometric features is becoming increasingly important. Such a biometric personal feature can be determined, for example, by scanning a fingerprint or by photographing the face or an eye of the user or by recording a sample of the user's handwriting.

To authorize a transaction, the user is usually instructed to enter the personal feature at a terminal and/or to make the feature accessible to the terminal. Here, however, there is the problem that the user does not in general have a reliable option for convincing himself/herself of the integrity of the terminal. If the user were to make his/her personal feature accessible to a terminal set up with fraudulent intent, then the user's personal feature, such as his/her fingerprint, could be recorded and later misappropriated by the falsified terminal.

German laid-open publication DE 41 42 964 A1 discloses a system in which a secret provided by the user—e.g., a password known only to the user—is stored in encrypted form in a chip card. Before the user is instructed to enter a PIN as a personal feature, a terminal reads out the encrypted password and displays it to the user in plain text. From the display of the correct password, the user can see that this is a terminal that can be trusted because a falsified terminal could not decrypt the encrypted code word.

The system described above, however, presupposes that the user is carrying a chip card or some other data carrier on which the encrypted password is stored with him/her. It would be more convenient for the user if this were not obligatorily necessary. In conjunction with biometric authorization procedures in particular, an additional requirement is often that no additional data carriers are to be used. For example, in biometric authorization of a payment transaction, this is an essential point in designing the procedure to be as simple as possible.

### SUMMARY OF THE INVENTION

Therefore, an object of the present invention is to avoid the aforementioned problems at least in part and to provide a technique for authorizing a transaction by a user using a terminal which gives the user an opportunity to recognize a falsified terminal. In some embodiments, the invention should be adapted especially to the use of biometric authorization techniques.

According to the invention, this object is achieved entirely or in part by a method executed by a terminal according to Claim 1, a method executed by a background system according to Claim 8, a method according to Claim 13, a device according to Claim 16 and a computer program product according to Claim 17. The dependent claims define preferred embodiments of the present invention for authorizing a transaction by a user using a terminal which is capable of communicating with a background system, with steps performed by the terminal: determining identification information which identifies the user, sending data to the background system to authenticate the terminal at the background system and to transmit user identification data from which the identity of the user can be derived, to the background system, receiving secret data assigned to the user from the background system, playing back a secret given by the secret data to the user, determining a personal feature of the user, and sending data which is related to the personal feature of the user to the background system to signal or document the authorization of the transaction by the user.

Further according to the invention, this object is achieved entirely or in part by a method for authorizing a transaction by a user, the method using a background system capable of communicating with a terminal, with steps performed by the background system: receiving data from the terminal, the data authenticating the terminal at the background system, the identity of the user being derivable from the data, if the authentication of the terminal at the background system has been successful, then accessing secret data stored in a database and assigned to the user, and sending data from which the secret data can be determined, to the terminal, and receiving data from the terminal, the data pertaining at least to a personal feature of the user and documenting the authorization of the transaction by the user.

Yet further according to the invention, this object is achieved entirely or in part by a method for authorizing a transaction by a user using a terminal capable of communicating with a background system, with the steps: determining, by the terminal, identification information which identifies the user, communicating between the terminal and the background system to authenticate the terminal at the background system and to transmit user identification data from which the identity of the user can be derived to the background system, if the authentication of the terminal at the background system has been successful, then the background system accesses secret data stored in a database and assigned to the user, and data from which the secret data can be determined is sent to the terminal, playing back, by the terminal, a secret given by the secret data to the user, determining, by the terminal, a personal feature of the user, and performing the transaction using data pertaining at least to the personal feature of the user.

The invention also comprises a terminal, a background system, and a computer program product.

The dependent claims concern features of some embodiments of the invention.

The present invention is based on the basic idea of storing data about a secret that is known only to the user in a background system (host system) with which the terminal is capable of exchanging data. The background system transmits the secret data of the user to the terminal only when the terminal has been successfully authenticated by the background system—i.e., has proven to be an authorized terminal. The background system usually stores secret data of many users so identification of the user is necessary before the background system can access the secret data assigned to the user.

The secret that is sent by the background system to the terminal in the form of secret data after successful authentication of the terminal is replayed to the user. The user can then be ensured that the terminal is trustworthy. To authorize the transaction, the user can then enter his/her personal feature or can make it accessible to the terminal without the user having to fear any misuse. The transaction is then performed, with the personal feature of the user serving to verify the authorization.

The invention offers the considerable advantage of an authentication of the terminal that can be verified by the user without requiring the user to have a data carrier. Acceptance of biometric authorization procedures can thereby be increased considerably, in particular because many users have concerns regarding possible misuse of their biometric data.

The order of enumeration of the steps in the method claims should not be understood as a restriction of the scope of protection. Instead, embodiments of the invention are provided in which these method steps are carried out in a different order or entirely or partially in parallel or entirely or partially interleaved. This pertains in particular to a possible interleaving of the related steps of the terminal and the background system in which data is acquired, transmitted and processed. Furthermore, in particular the authentication of the terminal at the background system and the transmission of the user's identification data to the background system may take place in a single step or in multiple substeps—in any order.

For authentication of the terminal at the background system, any method that would rule out the use of counterfeit terminals or would at least greatly impede such use may be employed here. As a rule, such authentication methods are based on a secret key of the terminal, and either symmetrical or asymmetrical encryption may be used. The terminal may transmit information to the background system for authentication, this information allowing the background system to determine whether the terminal has the secret key. The secret key itself, however, should not be accessible to an unauthorized person even if the unauthorized person taps into and analyzes a large number of communication operations between the terminal and the background system.

In some embodiments, a message secured with a MAC (message authentication code) or a cryptographic signature is used for authentication of the terminal. This message may contain user identification data that has been input into the terminal by the user or derived by the terminal from identification information pertaining to the user.

The secret that is supplied back to the user may be any type of information that is easily identified by the user and would be difficult or impossible for a counterfeit terminal to guess. Depending on the output options of the terminal, the information may consist of, for example, a displayed text and/or a displayed image and/or an acoustic output and/or tactile information.

To prevent the possibility of manipulation by spying on successful transactions of a user, some embodiments use a secret that changes from one transaction to the next and may, for example, be selected from a plurality of given secret information. In some embodiments, information regarding previous transactions, e.g., a photograph of the user at the last transaction performed—may be included in the secret or may form the secret.

In some embodiments, the personal feature of the user is a biometric feature. Depending on the embodiment of the terminal, for example, a fingerprint of the user may be determined and/or a sample of the user's signature may be recorded and/or a photograph or scan of the user or individual body parts of the user may be prepared and/or a voice sample of the user may be analyzed. However, this is not to exclude embodiments of the invention in which the personal feature is a password or a secret number or in which the personal feature is stored on a data carrier. However, such embodiments are less preferred because they are not so convenient for the user.

The personal feature is preferably transmitted by the terminal to the background system and is checked there. In the case of a successful check on the personal feature, the transaction is considered as having been authorized and the terminal may output a corresponding acknowledgement, for example. Embodiments in which the personal feature is checked entirely or partially by the terminal are not ruled out. To do so, however, it is usually necessary for information required for the check to be transmitted from the background system to the terminal, but this should be desirable only in exceptional cases for safety reasons.

In some embodiments, the communication transactions between the terminal and the background system are protected by suitable measures from spying and/or attacks by devices connected between them, especially so-called replay attacks. For example, time stamps and/or sequence numbers may be used for this purpose. In advantageous embodiments, an encryption of all messages—preferably with a session key that is issued again for each session—is provided.

The computer program product according to the invention has program instructions for implementing the method according to the invention in a terminal and/or a background system. Such a computer program product may be a physical medium, e.g., a semiconductor memory or a diskette or a CD-ROM. The computer program product may also be, for example, a non-physical medium, e.g., a signal transmitted over a computer network.

The device according to the invention may be in particular a terminal or a background system or a combination of a terminal and a background system. In some embodiments, the device and the computer program product have features which correspond to the features mentioned in the present description and/or in the dependent method claims.

### BRIEF DESCRIPTION OF THE DRAWINGS

Additional features, objects and advantages of the present invention are apparent from the following description of several exemplary embodiments and alternative embodiments. Reference is made to the schematic drawings in which:

FIG. 1 shows a system according to an exemplary embodiment of the invention in a schematic block diagram representation, and

FIG. 2A and FIG. 2B each show a section of an exemplary flow chart of a successfully authorized transaction in the system of FIG. 1.

### DETAILED DESCRIPTION OF EXEMPLARY EMBODIMENTS

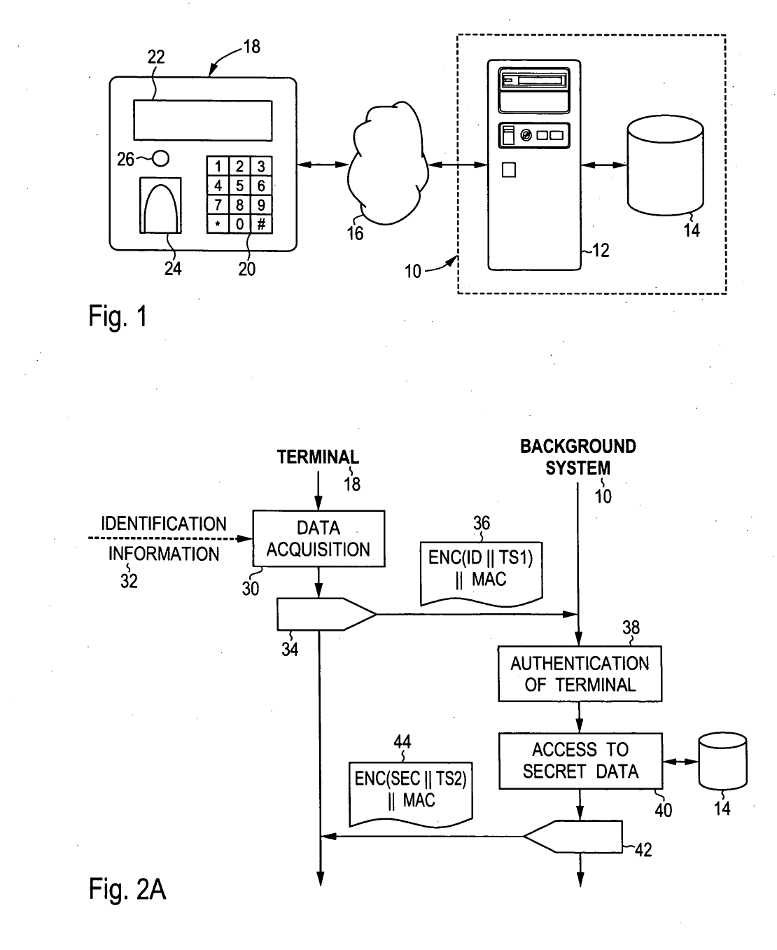

FIG. 1 shows a background system 10 having a server 12 and a database 14. The server 12 is embodied in the form of a powerful computer which is controlled by a program according to the method described below. The background system 10 serves, over a network 16, a plurality of terminals, one terminal 18 of which is shown as an example in FIG. 1. The network 16 may have multiple subsections which may be embodied, for example, as a local network and/or as a data packet network such as the Internet and/or as an analog or digital telephone network.

In the present exemplary embodiment, the terminal 18 is designed as a compact independent device which has operating elements such as a keyboard or keypad 20, display elements such as a graphic display 22 and elements for computing biometric features. In the present exemplary embodiment, a fingerprint sensor 24 and a camera 26 are provided for the latter purpose. In alternative embodiments, more or fewer or other biometric sensors may be provided. Furthermore, embodiments of the terminal 18 which do not have any biometric sensors but instead require input of a personal feature via the keyboard 20 are also conceivable.

In the exemplary embodiment illustrated in FIG. 1, the terminal 18 is designed as an independent device which is controlled by a built-in microprocessor according to the method described below. In simple embodiments, transaction data—e.g., a purchase price to be paid—is entered via the keyboard 20, but it is preferable for such data to be transmitted to the terminal 18 via an electronic interface (not shown in FIG. 1). A cash register, for example, may be connected to the interface. In other alternative embodiments, the terminal 18 is not an independent device but instead is incorporated, for example, into a cash register or an automatic apparatus or an access control device.

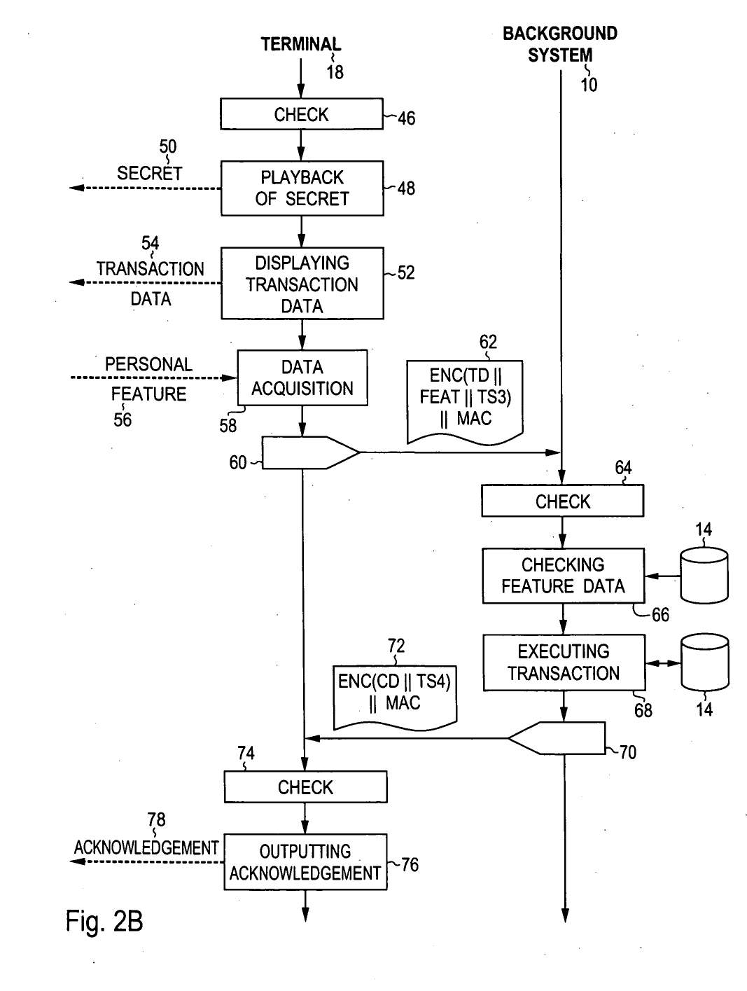

The sequence of a successfully authorized transaction illustrated in FIG. 2A and FIG. 2B begins in step 30 with an identification of the user, with identification information 32 being determined. At this point in time, the user cannot yet assume that the terminal 18 is trustworthy, so as a rule non-confidential identification information 32 is used. For example, in step 30 the user may enter as identification information 32 a customer number or a telephone number or his/her name—optionally together with his/her date of birth, if this is necessary for unambiguous identification—by using the keyboard 20 of the terminal 18.

In particular in the case of extensive identification information 32, the use of memory cards or memory modules may be provided in some embodiments. For example, the identification information 32 may be printed as plain text or as a bar code on a card and analyzed by a reader of the terminal 18—e.g., the cameras 26. In a similar way a magnetic card or a compact radio module (RF tag) may be used for convenient storage of the identification information 32, but then of course the terminal 18 must also be equipped with a suitable reader. The methods mentioned above are not mutually exclusive. For example, if the data carrier is not at hand, the user may enter his/her name and date of birth via the keyboard 20 as a more time-consuming alternative.

In another alternative embodiment, biometric information is used as the identification information 32. For example, a photograph of the user's face recorded by the camera 26 may be used for identification of the user. Furthermore, a fingerprint of the user recorded by the fingerprint sensor 24 may also be used, for example. If the transaction is authorized on the basis of a fingerprint, the user should use a different finger for identification purposes.

In step 34 the terminal 18 calculates data 36 that is transmitted to the background system 10. This data 34 contains in encrypted form user identification data ID and a first time stamp TS1. The encryption is indicated by the designation “ENC( . . . )” in FIG. 1; the symbol “∥” stands for joining two respective components of a message.

The user identification data ID is identical in some embodiments to the identification information 32 determined by the terminal 18 in step 30. This may be the case in particular if the identification information 32 is in compact form. However, if very extensive identification information 32 is obtained by the terminal 18, e.g., in the case of biometric data acquisition, preprocessing in the terminal 18 may be advantageous to derive suitable feature values to be used as the user identification data ID from the identification information 32.

The data transmitted to the background system 10 in step 34 is also protected by a data securing code, which is referred to below as MAC (message authentication code). Conceptually a MAC is a hash value or “fingerprint” into which is input first the message to be transmitted—in this case the encrypted user identification data ID and the first time stamp TS1—and also a secret key of the terminal 18. Methods of calculating a MAC are known and are described for example in chapter 9.5 of the book “Handbook of Applied Cryptography” by A. Menezes et al., CRC Press, 1996, pages 352-359.

In step 38 the background system 10 performs an authentication of the terminal 18. In the present exemplary embodiment, the background system 10 knows the secret key of the terminal 18 and can therefore check the MAC calculated by the terminal 18. In alternative embodiments, instead of a MAC based on a symmetrical encryption method, a cryptographic signature based on an asymmetrical method may be used. To analyze such a cryptographic signature, only a public key of the terminal 18 need be known to the background system 10. Furthermore, embodiments in which a session key is negotiated between the terminal 18 and the background system 10 and a secure encrypted communications channel is established are also conceivable.

If the authorization of the terminal 18 in step 38 fails, the method is terminated. Otherwise the background system 10 performs a search query in the database 14 in step 40 to access secret data SEC assigned to the user. There may be a search for an entry in the database 14 containing the user identification data ID in identical form or merely a similarity comparison may be performed. The latter is provided in particular when the user identification data ID is derived from biometric identification information 32.

Each entry assigned to a user in the database 14 contains secret data SEC on at least one secret of a user. In the present exemplary embodiment, a single static secret is used. Alternative embodiments with several secrets and/or dynamic secrets are described below.

In step 42, the secret data SEC determined from the database 14 is provided with a second time stamp TS2, encrypted and secured with another MAC. The data 44 thus obtained is transmitted to the terminal 18.

In step 46 (FIG. 2B) the terminal 18 first performs an authentication of the background system 10 on the basis of the MAC contained in the data 44. This authentication is less critical than the authentication in step 38 because a counterfeit background system 10 would not have any knowledge of the secret expected by the user. Furthermore, in step 46 the terminal 18 evaluates the second time stamp TS2 and checks on whether the time indicated there is later than the time of the first time stamp TS1. Some embodiments may also provide a check on whether or not a maximum allowed time difference has been exceeded between the two time stamps TS1 and TS2.

The check of the time stamp serves to protect against an attack in which a previous communication operation is recorded and played back (so-called replay attack). In alternative embodiments, instead of or in addition to the time stamps, random numbers may also be used to match requests and the corresponding responses and/or a send sequence counter may be used.

In step 48, the secret data SEC contained in encrypted form in the data 44 is decrypted and played back to the user as a secret 50. The secret 50 may be any type of information suitable for proving to the user that there has been successful authentication of the terminal 18 at the background system 10 in step 38. For example, as the secret 50, the user may be shown an image selected by the user or a password selected by the user and appearing on the display 22 of the terminal 18. In addition to or instead of the visual playback of the secret 50, an acoustic and/or tactile playback is also possible.

Before or after or simultaneously with the playback of the secret 50 in step 48, the transaction data 54 mentioned above, which may indicate the purchase price to be paid, for example, is displayed to the user in step 52. Display of the correct secret 50 signals to the user that the terminal 18 can be trusted because the background system 10 would transmit the secret 50 to the terminal 18 only after successful authentication of the terminal 18. Therefore, the user need not have any concerns about making accessible to the terminal 18 a personal feature 56 that has been established in advance.

The personal feature 56 may be, for example, a fingerprint which is input by the terminal 18 in step 58 when the user places his/her finger on the fingerprint sensor 24. In alternative embodiments, other biometric features, e.g., a password spoken by the user or the iris of the user recorded by the camera 26, may be used as the personal feature 56. Furthermore a biometric feature may be combined with a password input or code number input via the keyboard 20, or in some embodiments only a keyboard/keypad input may be provided or a keyboard/keypad input may be provided as an optional alternative to the biometric test.

The process whereby the user inputs the personal feature 56 into the terminal 18 or makes this feature accessible to the terminal 18 represents a declaration of intent with which the user authorizes the transaction. The user thereby states his/her consent, e.g., with the payment of the purchase price indicated in step 52.

The terminal 18 then converts the personal feature 56 determined in step 58 into feature data FEAT which is a compact representation of the personal feature 56. Such a conversion is desirable in particular for volume reduction of biometric data. In some alternative embodiments, the feature data FEAT and the personal feature 56 may also be identical.

The feature data FEAT is encrypted together with the transaction data 54 (labeled as “TD” in FIG. 2B) and a third time stamp TS3 and transmitted along with another MAC as data 62 to the background system 10. In step 64, the background system 10 checks the MAC and decrypts the data 62. Furthermore in step 64 the background system 10 performs a time stamp check to be sure that the third time stamp TS3 indicates a later point in time than the second time stamp TS2. If the check in step 64 has been successful, then in step 66 the background system 10 will perform a check of the feature data FEAT. In doing so, the background system 10 will access data contained in the database 14 in the entry assigned to the user.

Since the personal feature 56 in the exemplary embodiment described here is a biometric feature, in step 66 a corresponding biometric test method that has in particular a high reliability against false positive results must be performed. Such methods are known in many embodiments and as such are not the object of the present invention.

In case of a successful check of the personal feature 56 and/or the feature data FEAT in step 66, the transaction is executed in step 68. Depending on the type of transaction, for example, the background system 10 may relay data regarding the desired payment to an affiliated financial institution or may store such data in the data record assigned to the user in the database 14. If the check of the feature data FEAT in step 66 has yielded a negative result, the transaction is not performed and the method is terminated. The same thing of course also applies if one of the previous test steps 46 and 64 has failed.

Then in step 70, the background system 10 creates acknowledgement data CD regarding the successful transaction. This acknowledgement data CD is provided with a fourth time stamp TS4, encrypted and again secured with a MAC. The resulting data 72 is transmitted to the terminal 18 where in step 74 additional test steps pertaining to the MAC and the fourth time stamp TS4 are performed. If this check fails, a corresponding warning may be output to the user and/or the background system 10.

In the case of a successful check in step 74, the terminal 18 outputs the decrypted acknowledgement data CD as an acknowledgement 78 in step 76. The acknowledgement 78 may be displayed on the display 22, for example, or printed out by means of a printer (not shown in FIG. 1). The method is thus concluded.

With the exemplary embodiment described so far, a single static secret is provided for each user. However, alternative embodiments are possible in which several versions of secret data SEC corresponding to different codings of the secret 50 for differently equipped terminals 18 are stored in the database 14. In these embodiments, the terminal 18 transmits in step 34 additional information about the available playback options to the background system 10, and in step 42 the background system 10 makes available suitable secret data SEC.

As an alternative or in addition to different versions of a secret, the database 14 may also have secret data SEC for several different secrets for each user in some embodiments. The choice of one of these secrets in step 40 may then be made, e.g., randomly or according to a given sequence so that in step 48 a secret 50 that changes from one transaction to the next is displayed to the user. For such a dynamic secret, replay attacks based on replaying previous transactions are made considerably more difficult.

As an alternative or in addition to the aforementioned possibility of creating a dynamic secret, it is also possible to provide for the background system 10 to generate secret data SEC for a dynamic secret in step 40 depending on previous transactions. In particular, the dynamic secret may consist entirely or partially of information about the last transaction performed. Thus for example the date and/or amount of the last purchase and/or a photograph of the customer recorded by the camera 26 at the last transaction may serve as a dynamic secret. In these embodiments, the required data must of course also be stored in database 14.

It is self-evident that the details contained in the above description of exemplary embodiments should not be interpreted as restrictions of the scope of the present invention. Many modifications and other alternative embodiments are possible and are self-evident for those skilled in the art.

1. A method for authorizing a transaction by a user using a terminal which is capable of communicating with a background system, with steps performed by the terminal comprising:
determining identification information which identifies the user,
sending data to the background system to authenticate the terminal at the background system and to transmit user identification data from which the identity of the user can be derived, to the background system,
receiving secret data assigned to the user from the background system,
playing back a secret given by the secret data to the user,
determining a personal feature of the user, and
sending data which is related to the personal feature of the user to the background system to signal or document the authorization of the transaction by the user.

2. The method according to claim 1, wherein the terminal sends to the background system a message secured with at least one of a MAC and a cryptographic signature for authentication at the background system.

3. The method according to claim 2, wherein the message contains the user identification data that corresponds to the identification information determined by the terminal or has been derived from it.

4. The method according to claim 1, wherein the secret played back to the user is at least one of a text information, acoustic information, visual information, and tactile information.

5. The method according to claim 1, wherein transaction data is also displayed to the user.

6. The method according to claim 1, wherein the personal feature is a biometric feature of the user.

7. The method according to claim 1, further comprising receiving acknowledgement data from the background system and at least one of displaying and printing out an acknowledgement for the user.

8. A method for authorizing a transaction by a user, the method using a background system capable of communicating with a terminal, with steps performed by the background system comprising:
receiving data from the terminal, the data authenticating the terminal at the background system, the identity of the user being derivable from the data,
if the authentication of the terminal at the background system has been successful, then accessing secret data stored in a database and assigned to the user, and sending data from which the secret data can be determined to the terminal, and
receiving data from the terminal, the data pertaining at least to a personal feature of the user and documenting the authorization of the transaction by the user.

9. The method according to claim 8, wherein the secret data pertains to a secret which changes from one transaction to the next.

10. The method according to claim 9, wherein the secret data pertains to a secret which depends at least in part on transactions performed previously.

11. The method according to claim 8, wherein the data which pertains at least to the personal feature of the user is checked, and the transaction is considered as authorized by the user only if this check is successful.

12. The method according to claim 11, wherein acknowledgement data is sent to the terminal if the check is successful.

13. A method for authorizing a transaction by a user using a terminal capable of communicating with a background system, with the steps comprising:
determining, by the terminal, identification information which identifies the user,
communicating between the terminal and the background system to authenticate the terminal at the background system and to transmit user identification data from which the identity of the user can be derived to the background system,
if the authentication of the terminal at the background system has been successful, then the background system accesses secret data stored in a database and assigned to the user, and data from which the secret data can be determined is sent to the terminal,
playing back, by the terminal, a secret given by the secret data to the user,
determining, by the terminal, a personal feature of the user, and
performing the transaction using data pertaining at least to the personal feature of the user.

14. The method according to claim 13, wherein the communication processes between the terminal and the background system are protected from attacks at least in part by at least one of time stamps, sequence numbers, random numbers, and an encryption with a session key.

15. A terminal which is capable of communicating with a background system and which is equipped for authorizing a transaction by a user, wherein the terminal is adapted for:
determining identification information which identifies the user,
sending data to the background system to authenticate the terminal at the background system and to transmit user identification data from which the identity of the user can be derived, to the background system,
receiving secret data assigned to the user from the background system,
playing back a secret given by the secret data to the user,
determining a personal feature of the user, and
sending data which is related to the personal feature of the user to the background system to signal or document the authorization of the transaction by the user.

16. A background system which is capable of communicating with a terminal and which is equipped for authorizing a transaction by a user using the terminal, wherein the background system is adapted for:
receiving data from the terminal, the data authenticating the terminal at the background system, the identity of the user being derivable from the data,
if the authentication of the terminal at the background system has been successful, then accessing secret data stored in a database and assigned to the user, and sending data from which the secret data can be determined to the terminal, and
receiving data from the terminal, the data pertaining at least to a personal feature of the user and documenting the authorization of the transaction by the user.

17. A system comprising a background system and at least one terminal capable of communicating with the background system, the system being equipped for authorizing a transaction by a user, wherein the system is adapted for:
determining, by the terminal, identification information which identifies the user,
communicating between the terminal and the background system to authenticate the terminal at the background system and to transmit user identification data from which the identity of the user can be derived to the background system,
if the authentication of the terminal at the background system has been successful, then the background system accesses secret data stored in a database and assigned to the user, and data from which the secret data can be determined is sent to the terminal,
playing back, by the terminal, a secret given by the secret data to the user,
determining, by the terminal, a personal feature of the user, and
performing the transaction using data pertaining at least to the personal feature of the user.

18. A computer program product having program instructions for at least one processor of a terminal to cause the at least one processor to execute a method for authorizing a transaction by a user, the terminal being capable of communicating with a background system, with steps performed by the terminal comprising:
determining identification information which identifies the user,
sending data to the background system to authenticate the terminal at the background system and to transmit user identification data from which the identity of the user can be derived, to the background system,
receiving secret data assigned to the user from the background system,
playing back a secret given by the secret data to the user,
determining a personal feature of the user, and
sending data which is related to the personal feature of the user to the background system to signal or document the authorization of the transaction by the user.

19. A computer program product having program instructions for at least one processor of a background system to cause the at least one processor to execute a method for authorizing a transaction by a user, the background system being capable of communicating with a terminal, with steps performed by the background system comprising:
receiving data from the terminal, the data authenticating the terminal at the background system, the identity of the user being derivable from the data,
if the authentication of the terminal at the background system has been successful, then accessing secret data stored in a database and assigned to the user, and sending data from which the secret data can be determined to the terminal, and
receiving data from the terminal, the data pertaining at least to a personal feature of the user and documenting the authorization of the transaction by the user.
